(19) United States
(12) Patent Application Publication
(10) Pub. No.: US 2009/0164999 A1
(43) Pub. Date: Jun. 25, 2009

(54) Job execution system, portable terminal apparatus, job execution apparatus, job data transmission and receiving methods, and recording medium

(76) Inventors: Tomo Tsuboi, Itami-shi (JP); Tomoyuki Okamoto, Osaka (JP); Yasuji Takeuchi, Kobe-shi (JP); Nobuo Kamei, Osaka (JP)

Correspondence Address: BUCHANAN, INGERSOLL & ROONEY PC, POST OFFICE BOX 1404, ALEXANDRIA, VA, 22313-1404, US

(21) Appl. No.: 12/314,739

(22) Filed: Dec. 16, 2008

(30) Foreign Application Priority Data
Dec. 21, 2007 (JP) 2007-330739

(51) Int. Cl. G06F 13/00

(52) U.S. Cl. 718/101

(57) ABSTRACT

A job execution system has a portable terminal apparatus and a job execution apparatus capable of being interconnected. Job data stored in a storage of the portable terminal apparatus is automatically transmitted to the job execution apparatus, if establishment of a connection between the portable terminal apparatus and the job execution apparatus is detected on the portable terminal apparatus, or alternatively, if establishment of a connection between the portable terminal apparatus and the job execution apparatus is detected on the job execution apparatus and then a request for the job data is transmitted to the portable terminal apparatus from the job execution apparatus.

This application claims priority under 35 U.S.C. §119 to Japanese Patent Application No. 2007-330739 filed on Dec. 21, 2007, the entire disclosure of which is incorporated herein by reference in its entirety.

### BACKGROUND OF THE INVENTION

1. Field of the Invention

The present invention relates to a job execution system having a portable terminal apparatus and a job execution apparatus such as an image forming apparatus, capable of being interconnected; the portable terminal apparatus and the job execution apparatus preferably employed in this system; job data transmission and receiving methods; and a computer readable recording medium having job data transmission and receiving programs recorded therein to make a computer execute processing.

2. Description of the Related Art

The following description sets forth the inventor's knowledge of related art and problems therein and should not be construed as an admission of knowledge in the prior art.

Conventionally, portable terminal apparatuses such as a cell-phone and others load functions thereon to generate and obtain data, such as a camera and a browser. Specifically in recent years, data generated and obtained by these functions can be stored not only in memories of portable terminal apparatuses but also in recording mediums such as a SD card and others, and with increasing amount of data transmitted and received by portable terminal apparatuses, more users hope to print data stored in their using portable terminal apparatuses.

Further in recent years, data can be exchanged between a MFP (Multi Function Peripheral) that is a multifunctional digital image forming apparatus and a portable terminal apparatus, by using a close range wireless communication system such as Bluetooth. And users transmit to a MFP data stored in their using portable terminal apparatuses, in order to make the MFP print the data.

As disclosed in Japanese Unexamined Laid-open Patent Publication No. 2003-114773, for example, a cell-phone obtains data to be printed from a document server by using a first wireless means then transmits the data to a printer by using a second wireless means, and then the printer prints the data.

Further, as disclosed in Japanese Unexamined Laid-open Patent Publication No. 2006-215630, obtained data such as URL information, web page information, image data and etc. are preliminarily stored in a portable terminal apparatus, then the data is transmitted to a personal computer or a printer by using a wireless communication system, and then the personal computer or the printer obtains detailed information and performs a print operation, which is intended to reduce processing load on the portable terminal apparatus and save capacity of a recording medium.

With the conventional arts including those disclosed in the patent publications, in order to transmit to a MPF data stored in a portable terminal apparatus by using a close range wireless communication system or etc., a connection between the portable terminal apparatus and the MFP should be initially established, then a user using the portable terminal apparatus is requested to select data to be printed and issue an instruction to transmit the data.

Basically, in order to transmit data stored in a portable terminal apparatus to a MFP and make the MFP print the data, the MFP is necessarily occupied by a user using the portable terminal apparatus from the time a connection between the portable terminal apparatus and the MFP is established until completing a print operation. Meanwhile, the occupation time will be still longer if the user is requested to select data to be printed and issue an instruction to print the data after establishment of the connection, since the MFP is necessarily occupied by the user also during his/her operations to select data to be printed and issue a print instruction, which is inconvenient.

Further, this user using the portable terminal apparatus may be in no situation to issue a print instruction as soon as obtains data to be printed, since he/she does not always stand by in the vicinity of the MFP.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an objective of the present invention to provide a job execution system that is capable of shortening the occupation time of an image forming apparatus and properly making the image forming apparatus execute a job such as a print job that is related to data obtained by a portable terminal apparatus, when the data is transmitted from the portable terminal apparatus to the image forming apparatus.

It is another objective of the present invention to provide a portable terminal apparatus preferably employed in the job execution system.

It is yet another objective of the present invention to provide a job execution apparatus preferably employed in the job execution system.

It is still yet another objective of the present invention to provide a job data transmission method used in the job execution system.

It is still yet another objective of the present invention to provide a job data receiving method used in the job execution system.

It is still yet another objective of the present invention to provide a computer readable recording medium having a job data transmission program recorded therein to make a computer of the portable terminal apparatus execute a job data transmission process.

It is still yet another objective of the present invention to provide a computer readable recording medium having a job data receiving program recorded therein to make a computer of the portable terminal apparatus execute a job data receiving process.

According to a first aspect of the present invention, a job execution system has a portable terminal apparatus and a job execution apparatus, capable of being interconnected, and

the portable terminal apparatus includes:
a storage that stores in itself job data or reference information pointing to the job data:
a communicator that establishes a connection between the portable terminal apparatus and the job execution apparatus, and thereafter performs communication between the portable terminal apparatus and the job execution apparatus; and
a transmitter that transmits to the job execution apparatus the job data or the reference information stored in the storage, and
   the job execution apparatus includes:
a communicator that establishes a connection between the portable terminal apparatus and the job execution apparatus, and thereafter performs communication between the portable terminal apparatus and the job execution apparatus;
a receiver that receives the job data or the reference information transmitted from the portable terminal apparatus; and
an executor that executes a job that is related to the received job data or the job data obtained from an address referred to by the received reference information, and
   in this job execution system,
the transmitter of the portable terminal apparatus transmits to the job execution apparatus the job data or the reference information, if establishment of a connection between the portable terminal apparatus and the job execution apparatus is detected on the portable terminal apparatus, or alternatively, if establishment of a connection between the portable terminal apparatus and the job execution apparatus is detected on the job execution apparatus and then a request for the job data or the reference information is transmitted to the portable terminal apparatus from the job execution apparatus.

According to a second aspect of the present invention, a portable terminal apparatus includes:
a storage that stores in itself job data or reference information pointing to the job data;
a communicator that establishes a connection with a job execution apparatus, and thereafter performs communication with the job execution apparatus;
a detector that detects establishment of a connection with the job execution apparatus; and
a transmitter that transmits to the job execution apparatus the job data or the reference information stored in the storage, if the detector detects establishment of a connection with the job execution apparatus, or alternatively, if establishment of a connection with the job execution apparatus is detected on the job execution apparatus and then a request for the job data or the reference information is received from the job execution apparatus.

According to a third aspect of the present invention, a job execution apparatus includes:
a communicator that establishes a connection with a portable terminal apparatus, and thereafter performs communication with the portable terminal apparatus;
a detector that detects establishment of a connection with the portable terminal apparatus;
a requester that transmits to the portable terminal apparatus a request for job data or reference information pointing to the job data, if the detector detects establishment of a connection with the portable terminal apparatus;
a receiver that receives the job data or the reference information transmitted from the portable terminal apparatus in response to the request issued by the requester; and
an executor that executes a job that is related to the received job data or the job data obtained from an address referred to by the received reference information.

According to a fourth aspect of the present invention, a job data transmission method includes:
storing in a storage job data or reference information pointing to the job data;
establishing a connection with a job execution apparatus;
detecting establishment of a connection with the job execution apparatus; and
transmitting to the job execution apparatus the job data or the reference information stored in the storage, if establishment of a connection with the job execution apparatus is detected.

According to a fifth aspect of the present invention, a job data receiving method includes:
establishing a connection with a portable terminal apparatus;
detecting establishment of a connection with the portable terminal apparatus;
transmitting to the portable terminal apparatus a request for job data or reference information pointing to the job data, if establishment of a connection with the portable terminal apparatus is detected;
receiving the job data or the reference information transmitted from the portable terminal apparatus in response to the request; and
executing a job that is related to the received job data or the job data obtained from an address referred to by the received reference information.

According to a sixth aspect of the present invention, a computer readable recording medium having a job data transmission program recorded therein to make a computer of a portable terminal apparatus execute:
storing in a storage job data or reference information pointing to the job data;
establishing a connection with a job execution apparatus;
detecting establishment of a connection with the job execution apparatus; and
transmitting to the job execution apparatus the job data or the reference information stored in the storage, if establishment of a connection with the job execution apparatus is detected.

According to seventh aspect of the present invention, a computer readable recording medium having a job data receiving program recorded therein to make a computer of a job execution apparatus execute:
establishing a connection with a portable terminal apparatus;
detecting establishment of a connection with the portable terminal apparatus;
transmitting to the portable terminal apparatus a request for job data or reference information pointing to the job data, if establishment of a connection with the portable terminal apparatus is detected;
receiving the job data or the reference information transmitted from the portable terminal apparatus in response to the request; and
executing a job that is related to the received job data or the job data obtained from an address referred to by the received reference information.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing a configuration of a printing system that is a job execution system according to one embodiment of the present invention;

FIG. 2 is a block diagram showing a functional configuration of an image forming apparatus;

FIG. 3 is a block diagram showing a functional configuration of a portable terminal apparatus;

FIG. 4(A) is a flowchart showing a procedure executed in the portable terminal apparatus and FIG. 4(B) is a flowchart showing a procedure executed in the image forming apparatus;

FIG. 5 is a flowchart showing a subroutine corresponding to a folder creation process that is referred to Step S01 of the flowchart shown in FIG. 4(A);

FIG. 6 is a flowchart showing a subroutine corresponding to a data transmission process that is referred to Step S03 of the flowchart shown in FIG. 4(A);

FIG. 7 is a flowchart showing a subroutine corresponding to a data receiving process of the image forming apparatus, which is referred to Step S11 of the flowchart shown in FIG. 4(B);

FIG. 8 is a flowchart showing a subroutine corresponding to a data process that is referred to Step S12 of the flowchart shown in FIG. 4(B);

FIG. 9 is a view to explain another embodiment of the present invention, and includes FIG. 9(A) that is a flowchart showing a subroutine corresponding to a data receiving process of the image forming apparatus, which is referred to Step S11 of the flowchart shown in FIG. 4(B), and FIG. 9(B) that is a flowchart showing a subroutine corresponding to a data transmission process of the portable terminal apparatus, which is referred to Step S03 of the flowchart shown in FIG. 4(A);

FIG. 10 is a view to explain yet another embodiment of the present invention, and is a flowchart showing a subroutine corresponding to a data process that is referred to Step S12 of the flowchart shown in FIG. 4(B);

FIG. 11 is a view showing an example of a job ticket;

FIG. 12 includes FIG. 12(A) that is a flowchart showing a subroutine corresponding to a folder creation process that is referred to Step S01 of the flowchart shown in FIG. 4(A), and FIG. 12(B) that is a flowchart showing a subroutine corresponding to a data process that is referred to Step S12 of the flowchart shown in FIG. 4(B);

FIG. 13 is a view to explain still yet another embodiment of the present invention, and is a flowchart showing a subroutine corresponding to a folder creation process that is referred to Step S01 of the flowchart shown in FIG. 4(A);

FIG. 14 is a view to explain still yet another embodiment of the present invention, and is a flowchart showing a subroutine corresponding to a folder creation process that is referred to Step S01 of the flowchart shown in FIG. 4(A);

FIG. 15 is a view to explain still yet another embodiment of the present invention, and includes FIG. 15(A) that is a flowchart showing a subroutine corresponding to a folder creation process that is referred to Step S01 of the flowchart shown in FIG. 4(A), and FIG. 15(B) that is a flowchart showing a data transmission process that is referred to Step S03 of the flowchart shown in FIG. 4(A); and

FIG. 16 is a diagram showing transitions of screens displayed on the image forming apparatus when a job ticket received together with job data is edited by the image forming apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

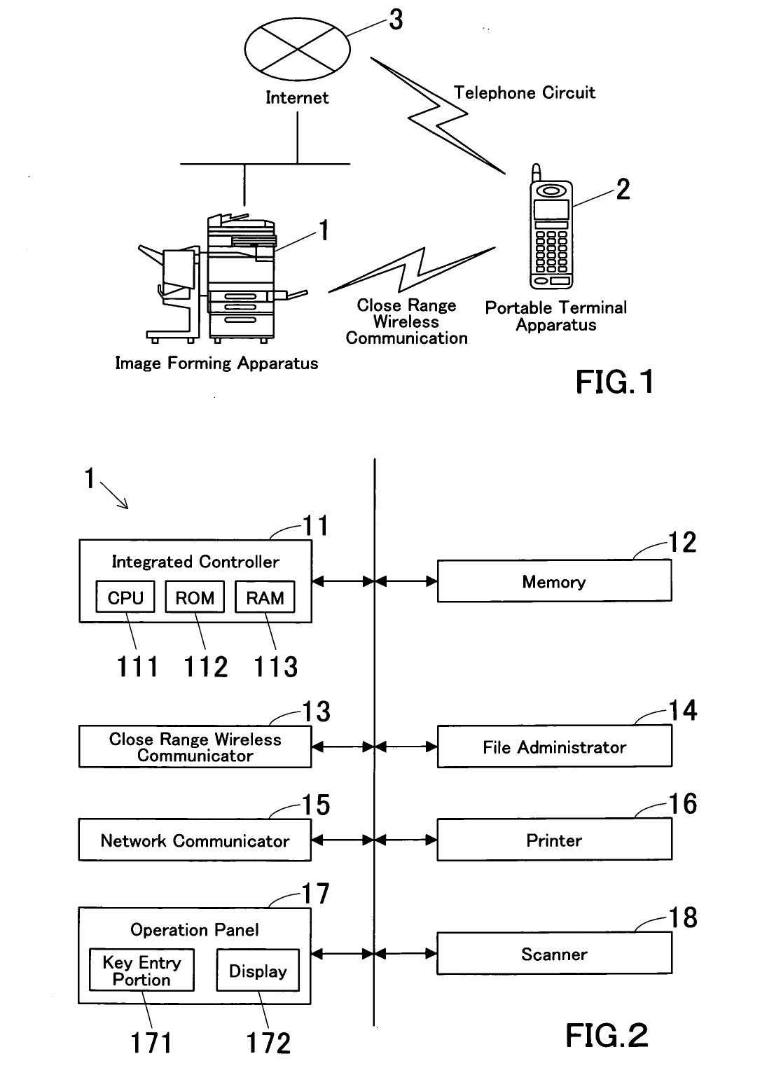

FIG. 1 is a view showing a configuration of a printing system that is a job execution system according to one embodiment of the present invention.

This printing system includes an image forming apparatus 1 that is a job execution apparatus such as a MFP, and a portable terminal apparatus 2 such as a cell-phone, and these apparatuses are capable of being connected to the Internet 3 and also being connected and communicating to each other by a close range wireless communication system such as Bluetooth.

FIG. 2 is a block diagram showing a functional configuration of the image forming apparatus 1.

This image forming apparatus 1 includes an integrated controller 11, a memory 12, a close range wireless communicator 13, a file administrator 14, a network communicator 15, a printer 16, an operation panel 17, a scanner 18 and etc.

The integrated controller 11 includes a CPU 111, a RAM 113, a ROM 112 and etc., and centrally controls the entire image forming apparatus 1. For example in this embodiment, under the control of the integrated controller 11, it is judged whether or not establishment of a connection with the portable terminal apparatus 2 is detected by the close range wireless communicator 13, and if establishment of the connection is detected, a request for job data or reference information pointing to the job data is transmitted to the portable terminal apparatus 2. Operations of the integrated controller 11 will be detailed later.

The memory 12 is a recording medium such as a hard disk, and stores in itself various data, setting information, application software and etc.

The close range wireless communicator 13 serves for establishing a connection with the portable terminal apparatus 2 by a close range wireless communication system, and performing communication after establishment of the connection. By this close range communicator 13, data can be exchanged with the portable terminal apparatus 2.

The file administrator 14 administers data files stored in the memory 13. The network communicator 15 connects the image forming apparatus 1 to a network such as the Internet 3.

The printer 16 prints on a sheet job data received from the portable terminal apparatus 2, print data received via the network from an external device such as a personal computer, image data read out from a document by the scanner 18, and other data. The printer 16 functions as a job executor.

The operation panel 17 is used by users to perform various entry operations, and displays on itself modes of the image forming apparatus 1 and messages for users. The operation panel 17 includes a key entry portion 171 collectively having numeric keys, a start key, a stop key and other keys, and a display 172 that is a touch-panel display with liquid crystal.

The scanner 18 reads an image on a document that is placed on a platen glass or an automatic document feeder, and converts it into image data that is electronic data.

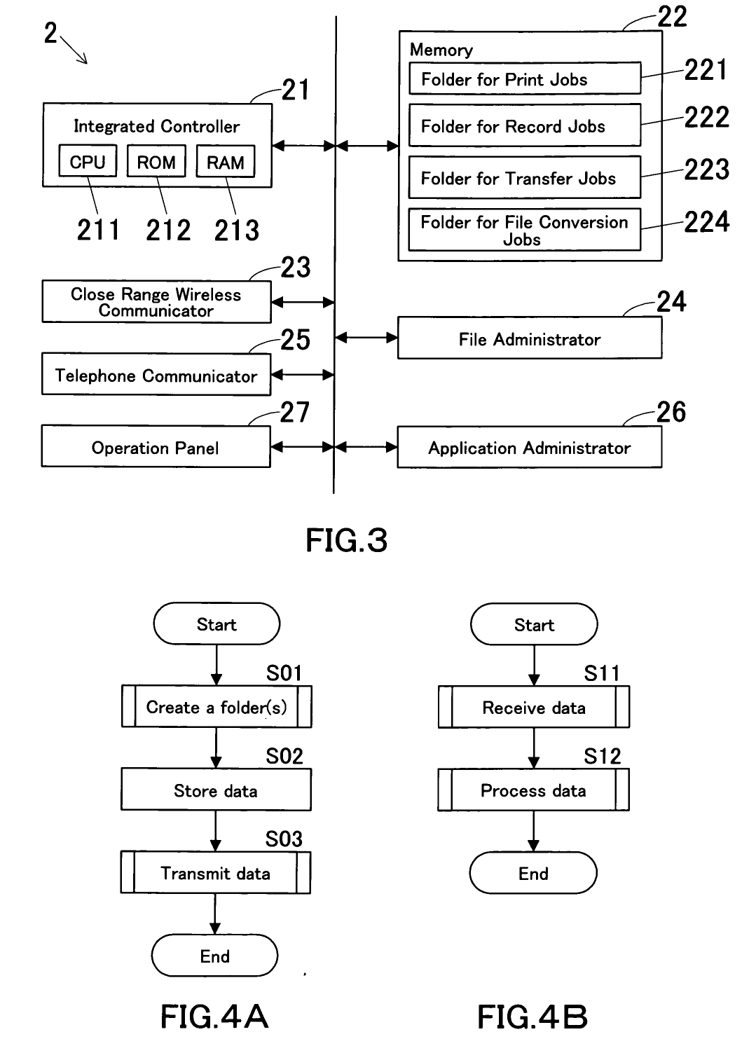

FIG. 3 is a block diagram showing a functional configuration of the portable terminal apparatus 2.

The portable terminal apparatus 2 includes an integrated controller 21, a memory 22, a close range wireless communicator 23, a file administrator 24, a telephone communicator 25, an application administrator 26, an operation panel 27, and etc.

The integrated controller 21 includes a CPU 211, a RAM 213, a ROM 212 and etc., and centrally controls the entire portable terminal apparatus 2. For example in this embodiment, under the control of the integrated controller 21, it is judged whether or not establishment of a connection with the image forming apparatus 1 is detected by the close range wireless communicator 23, and if establishment of the connection is detected, job data or reference information pointing to the job data is transmitted to the image forming apparatus 1. Operations of the integrated controller 21 will be detailed later.

The memory 22 stores in itself various data, setting information, application software and etc., and also functions as a storage to store job data of a job that a user hopes to make the image forming apparatus 1 execute, or reference information pointing to the job data. In this embodiment, the memory 22 has one or more than one folders to store job data or reference information pointing to the job data, and the respective folders are created to store the information by job types. For example in this embodiment, the memory 22 stores at least one from a print job folder 221 to store print jobs to print data by the image forming apparatus 1, a record job folder 222 to store record jobs to record data in the memory 12 of the image forming apparatus 1, a transfer job folder 223 to store transfer jobs to transfer data to an external device from the image forming apparatus 1, a file conversion job folder 224 to store file conversion jobs to convert the file format of data by the image forming apparatus 1, and other folders. Hereinafter, such folders to store job data are referred to also as “folders for data to be transmitted”.

The close range wireless communicator 23 serves for establishing a connection with the image forming apparatus 1 by a close range wireless communication system, and performing communication after establishment of the connection. By this close range communicator 23, data can be exchanged with the image forming apparatus 1.

The file administrator 24 administers data files stored in the memory 22. The phone communicator 25 connects the portable terminal apparatus 2 to the public phone line. The application administrator 16 administers application programs stored in the memory 22.

The operation panel 27 is used by users to perform various entry operations, and displays on itself modes of the image forming apparatus 1, messages for users, and etc.

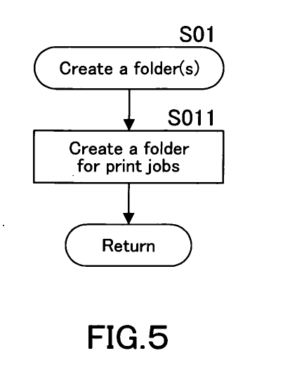

FIG. 4(A) is a flowchart showing a procedure executed in the portable terminal apparatus 2, and FIG. 4(B) is a flowchart showing a procedure executed in the image forming apparatus 1. The procedure of the portable terminal apparatus 2 is executed by the CPU 211 of the integrated controller 21 according to a program stored in the ROM 212 or the memory 22. And the procedure of the image forming apparatus 1 is executed by the CPU 111 of the integrated controller 11 according to a program stored in the ROM 112 or the memory 12.

As shown in FIG. 4(A), in the portable terminal apparatus 2, a folder is created in a folder creation process that is Step S01, and data is stored in the created folder in Step S02, and then a data transmission process is performed in Step S03. If there exists a folder already created therein in Step S01, the routine skips the folder creation process and proceeds to a data storing process that is Step S02. And if there exists data already stored therein in Step S02, the routine skips the data storing process and proceeds to a data transmission process that is Step S03.

On the other hand, as shown in FIG. 4(B), in the image forming apparatus 1, a data receiving process that is Step S11 and a data process that is Step S12 are performed.

FIG. 5 is a flowchart showing a subroutine corresponding to the folder creation process that is referred to Step S01 of the flowchart shown in FIG. 4(A). In this folder creation process, a folder for executing a job in a predetermined manner by the image forming apparatus 1 according to a user instruction in Step S011, is created. In this embodiment, a print job folder is created in this process just for an example, and a record job folder, a transfer job folder or a file conversion job folder may be created in this process. Further, the number of created folders is not limited to one, and more than one folders may be created in this process.

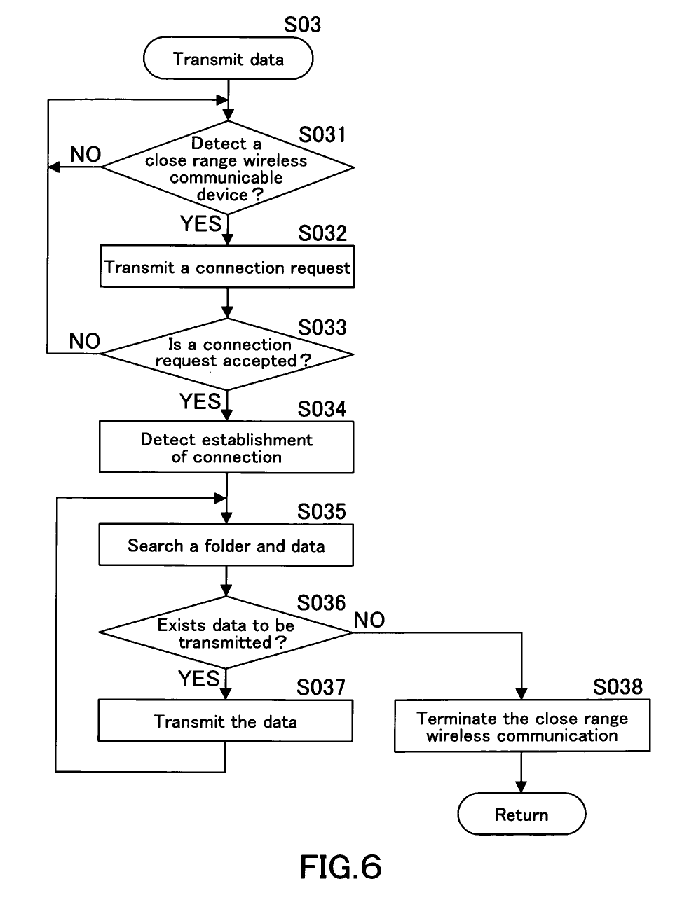

FIG. 6 is a flowchart showing a subroutine corresponding to the data transmission process that is referred to Step S03 of the flowchart shown in FIG. 4(A).

As for operations of the portable terminal apparatus 2, the subroutine waits until a close range wireless communicable device is detected by the close range wireless communicator 23, in Step S031. If a close range wireless communicable device is detected (YES in Step S031), a connecting process is performed as following. A connection request is transmitted to the detected device and the subroutine waits until a reply comes from the detected device, in Step S032. If the close range communicable device corresponds to the image forming apparatus 1 for example, the portable terminal apparatus 2 obtains from the image forming apparatus 1, unique code information thereof, which is apparatus information, then identifies the close range wireless communicable device exactly as the image forming apparatus 1 based on the obtained code information.

And in Step S033, it is judged whether or not a connection request is accepted by the image forming apparatus 1. If a connection request is not accepted by the image forming apparatus 1 (NO in Step S033), the subroutine goes back to Step S031. If a connection request is accepted (YES in Step S033), establishment of connection is detected in Step S034, and the folder created in Step S01 of FIG. 4(A) and data to be transmitted are searched through the memory 12, in Step S035. Then it is judged in Step S036 whether or not there exists data to be transmitted.

If there exists data to be transmitted (YES in Step S036), the data including job data is transmitted to the image forming apparatus 1 in Step S037, and the subroutine goes back to Step S35 in which other data to be transmitted is searched. If there does not exist any data to be transmitted (NO in Step S036), the close range wireless communication with the image forming apparatus 1 is terminated in Step S038. Then the subroutine returns to the main routine.

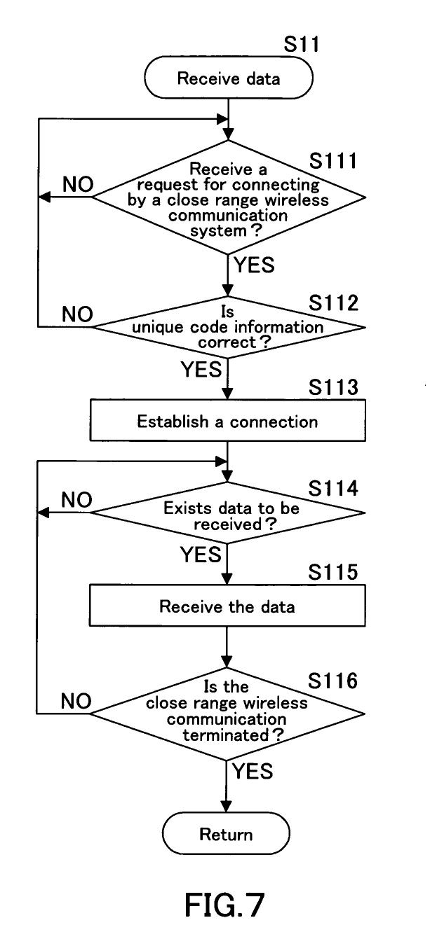

FIG. 7 is a flowchart showing a subroutine corresponding to the data receiving process of the image forming apparatus 1, which is referred to Step S11 of the flowchart shown in FIG. 4(B).

In Step S111, the routine waits until a request for connecting by a close range wireless communication system is received. If a connection request is received (YES in Step S111), a connecting process is performed as following. It is judged in Step S112 whether or not unique code information of the image forming apparatus 1, which is transmitted to and then returned from the portable terminal apparatus 2, is correct. If it is not correct (not OK) (NO in Step S112), the subroutine goes back to Step S111. If it is correct (YES in Step S112), a connection with the portable terminal apparatus 2 is established in Step S113, then it is judged in Step S114 whether or not there exists data to be received from the portable terminal apparatus 2.

If there does not exist any data to be received (NO in Step S114), the routine stays in Step S114 until data to be received is detected. If there exists data to be received (YES in Step S114), the data including job data is received from the portable terminal apparatus 2 in Step S115. Then the subroutine proceeds to Step S116.

In Step S116, it is judged whether or not the close range wireless communication with the portable terminal apparatus 2 is terminated. If it is not yet terminated (NO in Step S116), the subroutine goes back to Step S114. If it is terminated (YES in Step S116), the subroutine returns to the main routine.

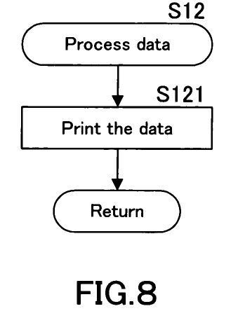

FIG. 8 is a flowchart showing a subroutine corresponding to the data process that is referred to Step S12 of the flowchart shown in FIG. 4(B).

Receiving job data from the portable terminal apparatus 2, the image forming apparatus 1 prints the received job data based on the information indicating its job type, in Step S12. Then the subroutine returns to the main routine. In this case, a print operation may be performed under a condition set in advance about each job data, on the image forming apparatus 1, for example. Alternatively, as to be describe later, a print operation may be performed under a job condition set about each folder, which is received from the portable terminal apparatus 2.

If folders storing job data, which exists in the memory 22 of the portable terminal apparatus 2, are not the print job folder 221, but at least one from the record job folder 222, the transfer job folder 223 and the file conversion folder 224, the received job data is stored in the memory 12 of the image forming apparatus 1, transferred to an external device, or converted to another file format of data, depending on the folder types.

As described above in this embodiment, if the portable terminal apparatus 2 detects establishment of a connection between the image forming apparatus 1 and the portable terminal apparatus 2, job data stored in the folders 221 through 224 existing in the memory 22 of the portable terminal apparatus 2, is automatically transmitted to the image forming apparatus 1. Thus, a user using the portable terminal apparatus 2 does not have to manually perform the operations of selecting job data to be transmitted and giving an instruction to transmit the job data, and it is advantageous that the occupation time of the image forming apparatus 1 is shortened by the time for user's performing such manual operations. Further, in this embodiment, job data stored in the folders 221 through 224 existing in the portable terminal apparatus 2 is transmitted to the image forming apparatus 1. Therefore, when obtains preferable job data that is related to a print job for example, a user using the portable terminal apparatus 2 simply has to store the job data in the folder 221, 222, 223 or 224 depending on its job type, and thereby this job is properly transmitted then executed by the image forming apparatus 1.

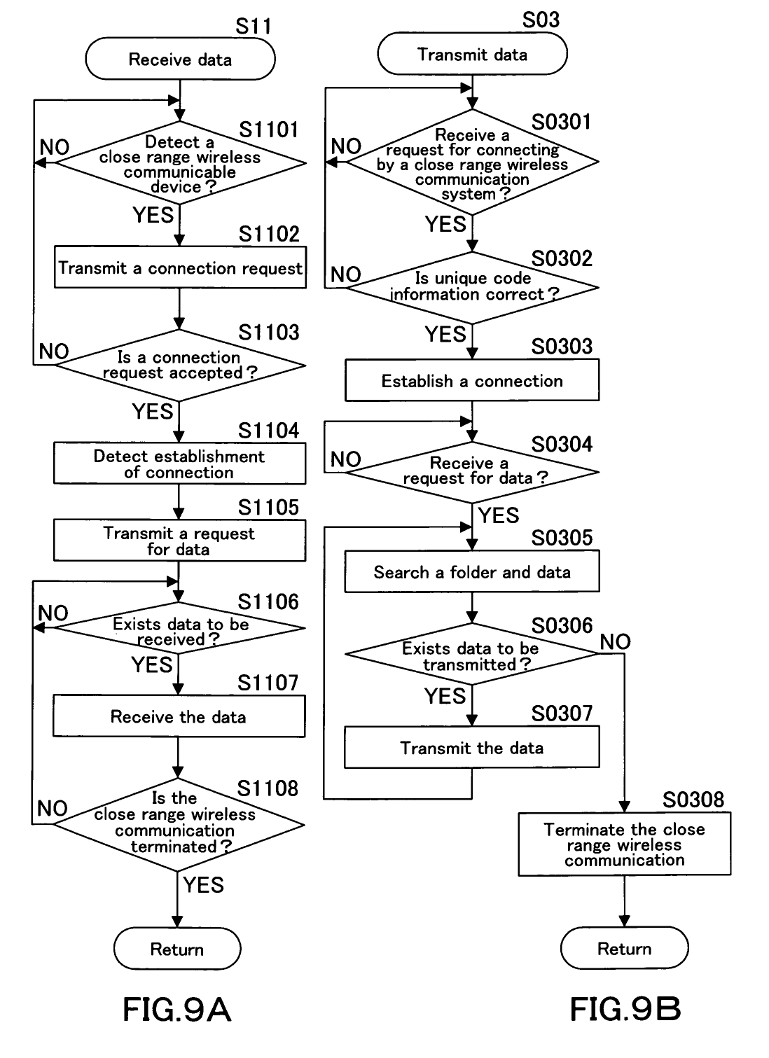

FIG. 9 is a view to explain another embodiment of the present invention. In this embodiment, the portable terminal apparatus 2 transmits job data and etc. to the image forming apparatus 1 in response to a request for job data, which is received from the image forming apparatus 1.

FIG. 9(A) is a flowchart showing a subroutine corresponding to the data receiving process of the image forming apparatus 1, which is referred to Step S11 of the flowchart shown in FIG. 4(B).

The subroutine waits until a close range wireless communicable device is detected by the close range wireless communicator 13, in Step S1101. If a close range wireless communicable device is detected (YES in Step S1101), a connection request is transmitted to the detected device and the subroutine waits until a reply comes from the detected device, in Step S1102. If the close range communicable device corresponds to the portable terminal apparatus 2 for example, the image forming apparatus 1 obtains from the portable terminal apparatus 2, unique code information thereof, which is apparatus information, then identifies the close range wireless communicable device exactly as the portable terminal apparatus 2 based on the obtained code information.

And in Step S1103, it is judged whether or not the connection request is accepted by the portable terminal apparatus 2. If the connection request is not accepted (NO in Step S1103), the subroutine goes back to Step S1101. If the connection request is accepted (YES in Step S1103), establishment of the connection is detected in Step S1104, and a request for job data is transmitted to the portable terminal apparatus 2 in Step S1105.

Subsequently in Step S1106, it is judged whether or not there exists data to be received from the portable terminal apparatus 2. If there does not exist any data to be received (NO in Step S1106), the subroutine stays in Step S1106. If there exists data to be received (YES in Step S1106), the data is received from the portable terminal apparatus 2 in Step S1107, then the subroutine proceeds to Step S1108.

In Step S1108, it is judged whether or not the close range wireless communication with the portable terminal apparatus 2 is terminated. If it is not terminated (NO in Step S1108), the subroutine goes back to Step S1106. If it is terminated (YES in Step S1108), the subroutine returns to the main routine.

FIG. 9(B) is a flowchart corresponding to a subroutine showing the data transmission process of the portable terminal apparatus 2, which is referred to Step S03 of the flowchart shown in FIG. 4(A).

In Step S0301, the routine waits until a request for connecting by a close range wireless communication system is received. If a connection request is received (YES in Step S0301), it is judged in Step S0302 whether or not unique code information of the portable terminal apparatus 2, which is transmitted to and then returned from the image forming apparatus 1, is correct. If it is not correct (not OK) (NO in Step S0302), the subroutine goes back to Step S0301. If it is correct (YES in Step S0302), a connection with the image forming apparatus 1 is established in Step S0303, then it is judged in Step S0304 whether or not a request for data is received from the image forming apparatus 1.

If a request for data is not received (NO in Step S0304), the subroutine stays in Step S0304 until it is received. If a request for data is received (YES in Step S0304), the folders 221 through 224 and data to be transmitted, which is stored in these folders, are searched through the memory 22, in Step S0305. Then it is judged in Step S0306 whether or not there exists data to be transmitted.

If there exists data to be transmitted (YES in Step S0306), the data including job data and etc. is transmitted to the image forming apparatus 1 in Step S0307, then the subroutine goes back to Step S0305 in which other data to be transmitted is searched. If there does not exist any data to be transmitted (NO in Step S0306), the close range wireless communication is terminated in Step S0308. Then the subroutine returns to the main routine.

As described above in this embodiment, if the image forming apparatus 1 detects establishment of a connection between the image forming apparatus 1 and the portable terminal apparatus 2 then the portable terminal apparatus 2 receives a request for job data from the image forming apparatus 1, job data stored in the folders 221 through 224 existing in the memory 22 of the portable terminal apparatus 2, is automatically transmitted to the image forming apparatus 1. Thus, a user using the portable terminal apparatus 2 does not have to manually perform the operations of selecting job data to be transmitted and giving an instruction to transmit the job data, and it is advantageous that the occupation time of the image forming apparatus 1 is shortened by the time for user's performing such manual operations.

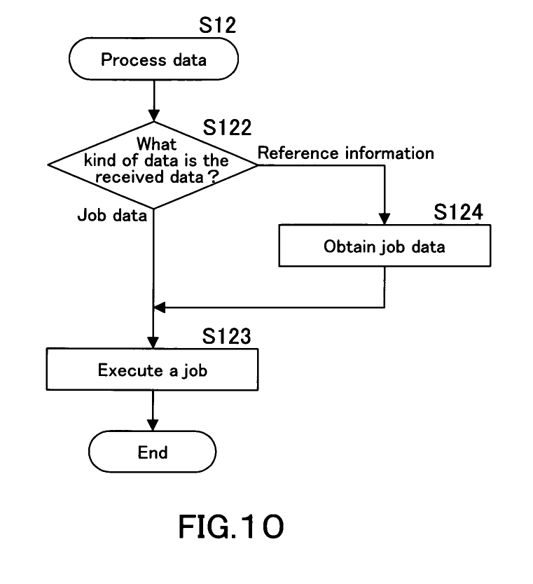

FIG. 10 is a view to explain yet another embodiment of the present invention, and is a flowchart corresponding to a subroutine showing the data process that is referred to Step S12 of the flowchart shown in FIG. 4(B).

In the embodiments described before this present embodiment shown in FIG. 10, job data stored in the folders 221 through 224 existing in the memory 22 of the portable terminal apparatus 2, is transmitted to the image forming apparatus 1. On the other hand, in this present embodiment shown in FIG. 10, one or more than one reference information pointing to job data, which is stored in the folders 221 through 224, is transmitted to the image forming apparatus 1.

As for operations of the image forming apparatus 1, it is judged in Step S122, what kind of data the received data is, in other words, whether job data or reference information pointing to job data, the received data is.

If it is job data (“job data” in Step S122), the subroutine proceeds to Step S123. If it is reference information (“reference information” in Step S122), job data is obtained by gaining access to the address referred to by reference information in Step S124, then the subroutine proceeds to Step S213. If the job data exists in an external device for example, it is obtained via network.

In Step S123, a job related to the received or obtained job data, such as a print job, is executed. Then the subroutine returns to the main routine.

As described above in this embodiment, if the portable terminal apparatus 2 transmits to the image forming apparatus 1 reference information pointing to job data, the image forming apparatus 1 automatically obtains job data by using the reference information then executes a job such as a print job. And it is advantageous that the portable terminal apparatus 2 simply transmits to the image forming apparatus 1 the reference information pointing to job data no matter how large the size of the job data is, and thereby the occupied area of the memory 22 of the portable terminal apparatus 2 is saved.

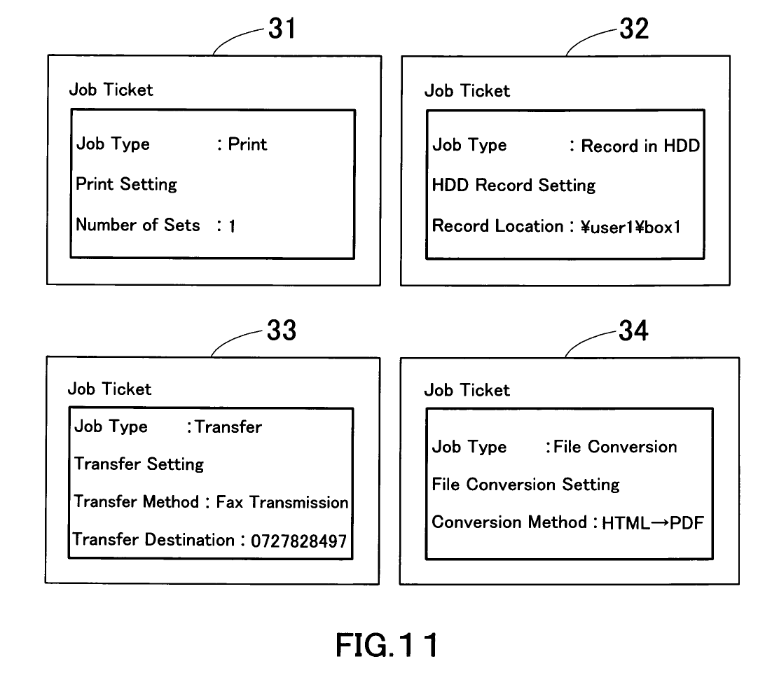

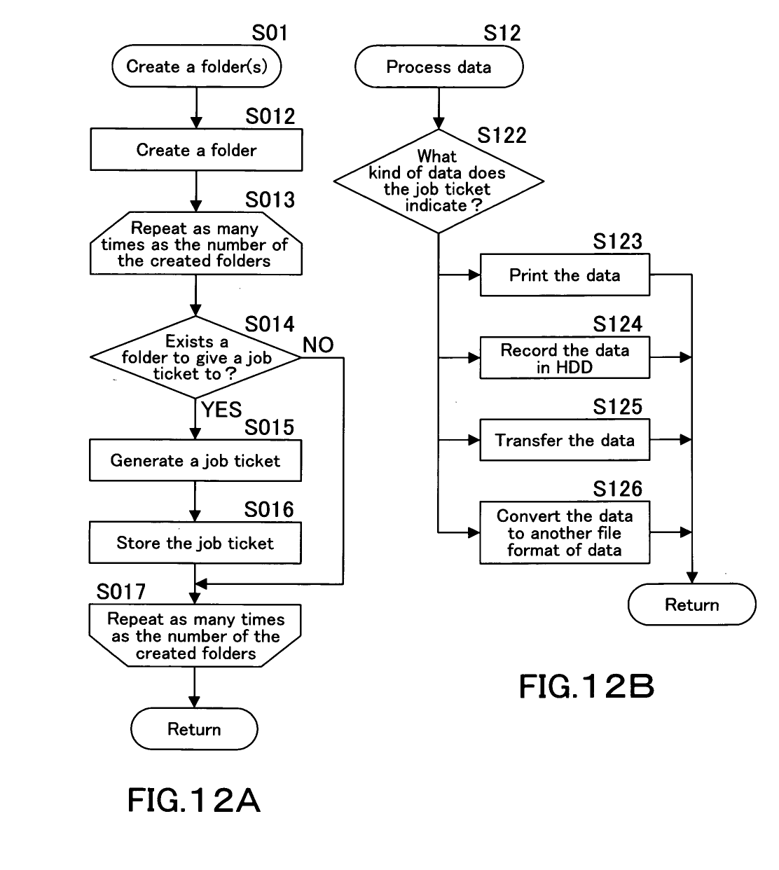

FIG. 11 and FIG. 12 are views to explain still yet another embodiment of the present invention.

In this embodiment, one or more than one folders 221 through 224 are created in the memory 22 of the portable terminal apparatus 2, and a job condition (referred to also as “job ticket”) that is a condition for executing a job, is given to each of the folders, in other word, a job condition is given to each job type. And one or more than one job data stored in a folder as well as one job ticket given to the folder are transmitted to the image forming apparatus 1 at the same time. And then, the image forming apparatus 1 executes a job related to the job data according to the job ticket.

FIG. 11 shows examples of the job ticket. These are four job tickets that are job tickets 31 through 34.

The job ticket 31 is given to the folder 221 for print jobs, and their job type is “print”. The number of sets to be outputted is set to “1” as a print setting, for example.

The job ticket 32 is given to the folder 222 for record jobs, and their job type is “record in a recording medium (hard disk drive: HDD)”. The record location is set as “ [symbol] user1 [symbol] box1” as a record setting, for example.

The job ticket 33 is given to the folder 223 for transfer jobs, and their job type is “transfer”. The transfer method is set to “FAX transmission” and the transfer destination is set as “0727828497”, as transfer settings.

The job ticket 34 is given to the folder 224 for file conversion jobs, and their job type is “file conversion”. The conversion method is set to “convert HTML to PDF” as a file conversion setting.

FIG. 12(A) is a flowchart corresponding to a subroutine showing the folder creation process that is referred to Step S01 of the flowchart shown in FIG. 4(A), and FIG. 12(B) is a flowchart corresponding to a subroutine showing the data process that is referred to Step S12 of the flowchart shown in FIG. 4(B).

As shown in FIG. 12(A), one or more than one folders that are the folders 221 through 224, are created for each job type according to user instruction, in Step S012. Then the subroutine repeats Step S014 through Step S016 as many times as the number of the created folders (Steps S013 and S017).

Concretely, it is judged in Step S014 whether or not there exists a folder to give a job ticket to. If there does not exist any folder (NO in Step S014), the subroutine directly returns to the main routine. If there exists a folder (YES in Step S014), an appropriate job ticket is generated for the folder according to user instruction then stored in the folder, in Step S015. The subroutine repeats these processes as many times as the number of the created folders, then returns to the main routine.

As shown in FIG. 12(B), receiving from the portable terminal apparatus 2 the job data and the job ticket stored in the folders 221 through 224, the image forming apparatus 1 executes a job related to the job data according to the job ticket. In other words, the job data is printed (Step S123), the job data is recorded in a recording medium that is a hard disk drive (Step S124), the job data is transferred to an external device, or the job data is converted to another file format of data (Step S126), according to the job ticket.

As described above in this embodiment explained with FIG. 11 and FIG. 12, the image forming apparatus 1 executes a job related to job data stored in the folders 221 through 224, according to a job ticket given to each of the folders. Thus, a user using the portable terminal apparatus 2 does not have to manually perform the operation of setting a job condition about each job data, which would improve user convenience.

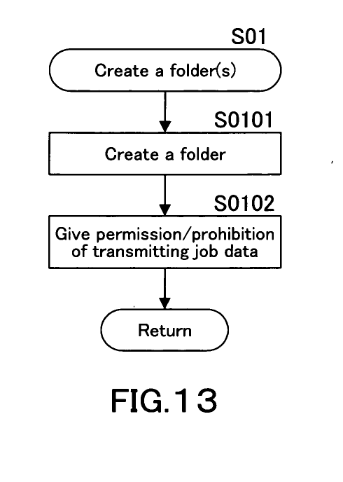

FIG. 13 is a view to explain still yet another embodiment of the present invention, and is a flowchart corresponding to a subroutine showing the folder creation process that is referred to Step S01 of the flowchart shown in FIG. 4(A). In this embodiment, users are allowed to give permission/prohibition of transmitting job data to the image forming apparatus 1.

As for operations of the portable terminal apparatus 2, a folder is created in Step S0101. Then in Step S0102, permission/prohibition of transmitting to the image forming apparatus 1 job data stored in the created folder is given according to user instruction. Permission/prohibition of transmitting job data may be given to each folder, and may be given to each image forming apparatus 1. Therefore, job data that is stored only in a folder having permission of transmitting job data is transmitted to the image forming apparatus 1, meanwhile job data that is stored in a folder having prohibition of transmitting job data is not transmitted to the image forming apparatus 1. Further, job data is not transmitted to an image forming apparatus 1 having prohibition of transmitting job data, even if the job data is stored in a folder having permission of transmitting job data.

As described above in this embodiment, users are allowed to configure a setting specifying whether or not to transmit job data to the image forming apparatus 1, about each of the folders 221 through 224 existing in the memory 22 of the portable terminal apparatus 2, and also about each image forming apparatus 1. Thus, users can reflect their intention whether or not to transmit, which would improve user convenience.

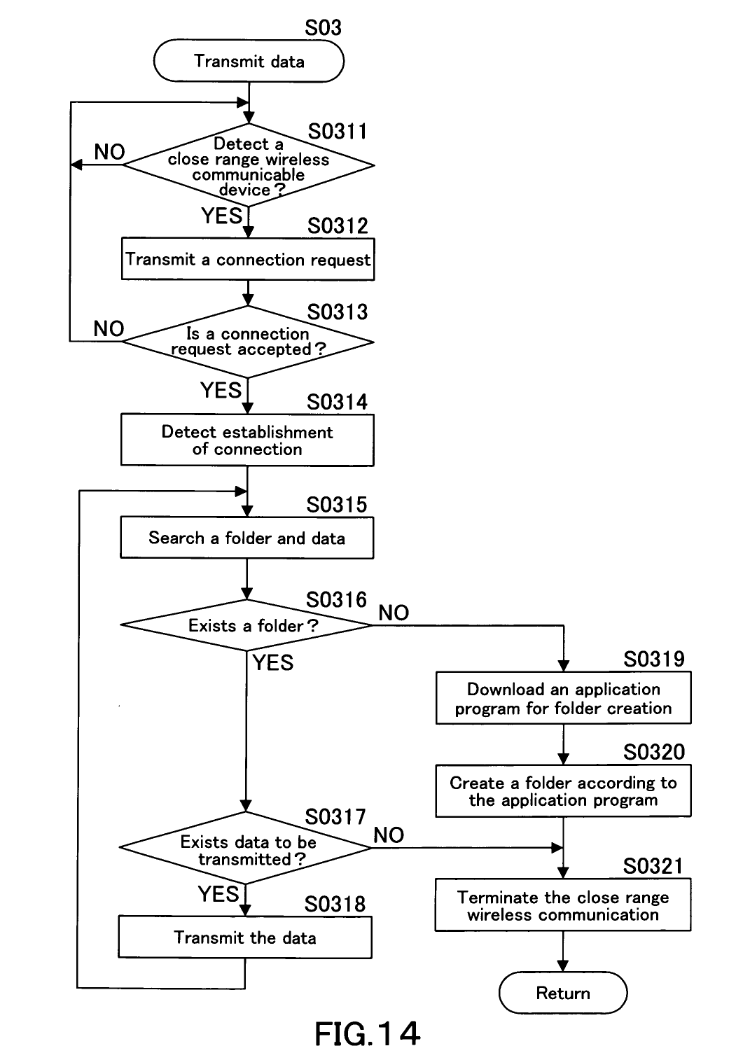

FIG. 14 is a view to explain still yet another embodiment of the present invention, and is a flowchart corresponding to a subroutine showing the data transmission process that is referred to Step S03 of the flowchart shown in FIG. 4(A).

In this embodiment, if the folders 221 through 224 are not yet created in the memory 22 of the portable terminal apparatus 2, an application program for folder creation is downloaded from the image forming apparatus 1, then a folder is created according to the application program.

As for operations of the portable terminal apparatus 2, the subroutine waits until a close range wireless communicable device that is the image forming apparatus 1 is detected by the close range wireless communicator 23, in Step S0311. If the image forming apparatus 1 is detected (YES in Step S0311), a connection request is transmitted to the detected image forming apparatus 1 and the subroutine waits until a reply comes form the image forming apparatus 1, in Step S0312.

And in Step S0313, it is judged whether or not a connection request is accepted by the image forming apparatus 1. If a connection request is not accepted by the image forming apparatus 1 (NO in Step S0313), the subroutine goes back to Step S0311. If a connection request is accepted (YES in Step S0313), establishment of connection is detected in Step S0314, and a folder and job data are searched through the memory 22 in Step S0315, and then it is judged in Step S0316 whether or not there exists any folder therein. If there exists a folder (YES in Step S0316), it is judged in Step S0317 whether or not there exists in the folder data to be transmitted.

If there exists data to be transmitted (YES in Step S0317), the data including job data is transmitted to the image forming apparatus 1 in Step S0318, then the subroutine goes back to Step S0315. If there does not exist any data to be transmitted (NO in Step S0317), the close range wireless communication is terminated in Step S0321, then the subroutine returns to the main routine.

Meanwhile, if there does not exist any folder (NO in Step S0316), an application program for folder creation is downloaded from the image forming apparatus 1 in Step S0319, and a folder is created according to the application program in Step S0320. And the subroutine proceeds to Step S0321 in which the close range wireless communication is terminated. Then the subroutine returns to the main routine.

As described above in this embodiment, it is very advantageous that the folders 221 through 224 can be created according to an application program for folder creation, which is downloaded from the image forming apparatus 1, if there does not exist any folder in the portable terminal apparatus 2 when a connection with the image forming apparatus 1 is established.

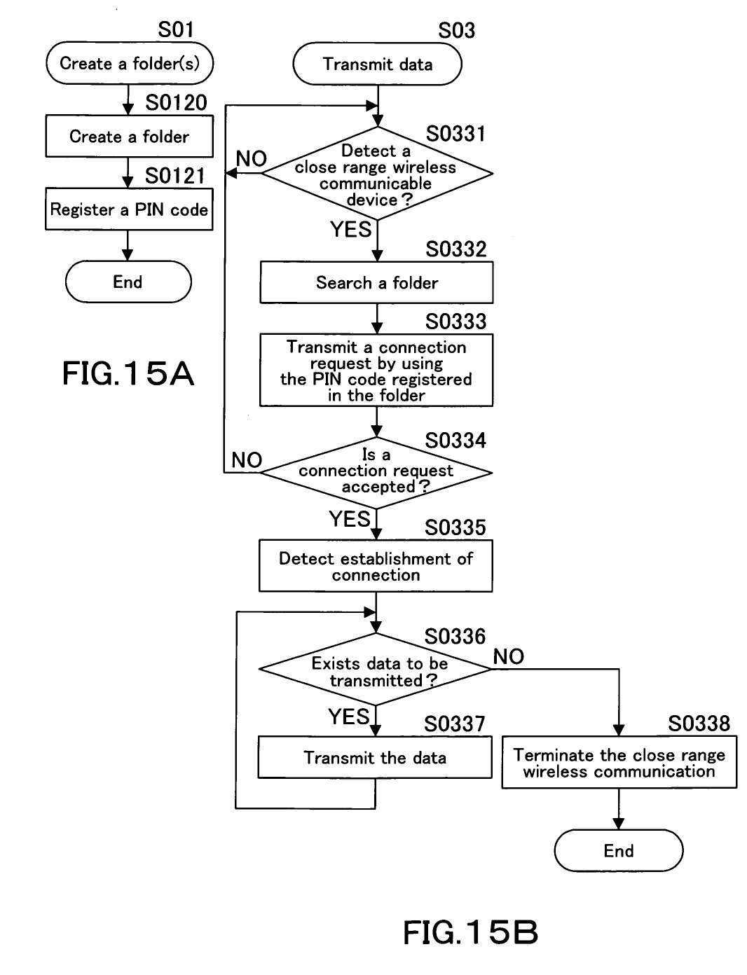

FIG. 15 is a view to explain still yet another embodiment of the present invention, and includes FIG. 15(A) that is a flowchart corresponding to a subroutine showing the folder creation process that is referred to Step S01 of the flowchart shown in FIG. 4(A), and FIG. 15(B) that is a flowchart corresponding to a subroutine showing the data transmission process that is referred to Step S03 of the flowchart shown in FIG. 4(A).

In this embodiment, the portable terminal apparatus 2 establishes a connection with the image forming apparatus 1 by using a PIN (Personal Identification Number) code registered in the folders 221 through 224, by a close range wireless communication system.

As shown in FIG. 15(A), in the portable terminal apparatus 2, a folder is created in Step S0120, and a PIN code is registered in the folder, in Step S0121.

Meanwhile, as shown in FIG. 15(B), in the data transmission process of portable terminal apparatus 2, the subroutine waits until the image forming apparatus 1 is detected by the close range wireless communicator 23, in Step S0331. If the image forming apparatus 1 is detected (YES in Step S0331), the folder for transmission 221, 222, 223 or 224 is searched in Step S0332. Then in Step S0333, a connection request is transmitted to the image forming apparatus 1 by using the PIN code registered in the folder and the subroutine waits until a reply comes from the image forming apparatus 1.

Subsequently in Step S0334, it is judged whether or not a connection request is accepted by the image forming apparatus 1. If a connection request is not accepted by the image forming apparatus 1 (NO in Step S0334), the subroutine goes back to Step S0331.

If a connection request is accepted (YES in Step S0334), establishment of connection is detected in Step S0335. And in Step S0336, data to be transmitted is searched through the folder and it is judged whether or not there exists any data to be transmitted.

If there exists data to be transmitted (YES in Step S0336), the data including job data is transmitted to the image forming apparatus 1 in Step S0337, then the subroutine goes back to Step S0336. If there does not exist any data to be transmitted (NO in Step S0336), the close range wireless communication is terminated in Step S0338, then the subroutine returns to the main routine.

As described above in this embodiment, a connection with the image forming apparatus 1 is properly established by using a PIN code registered in each folder.

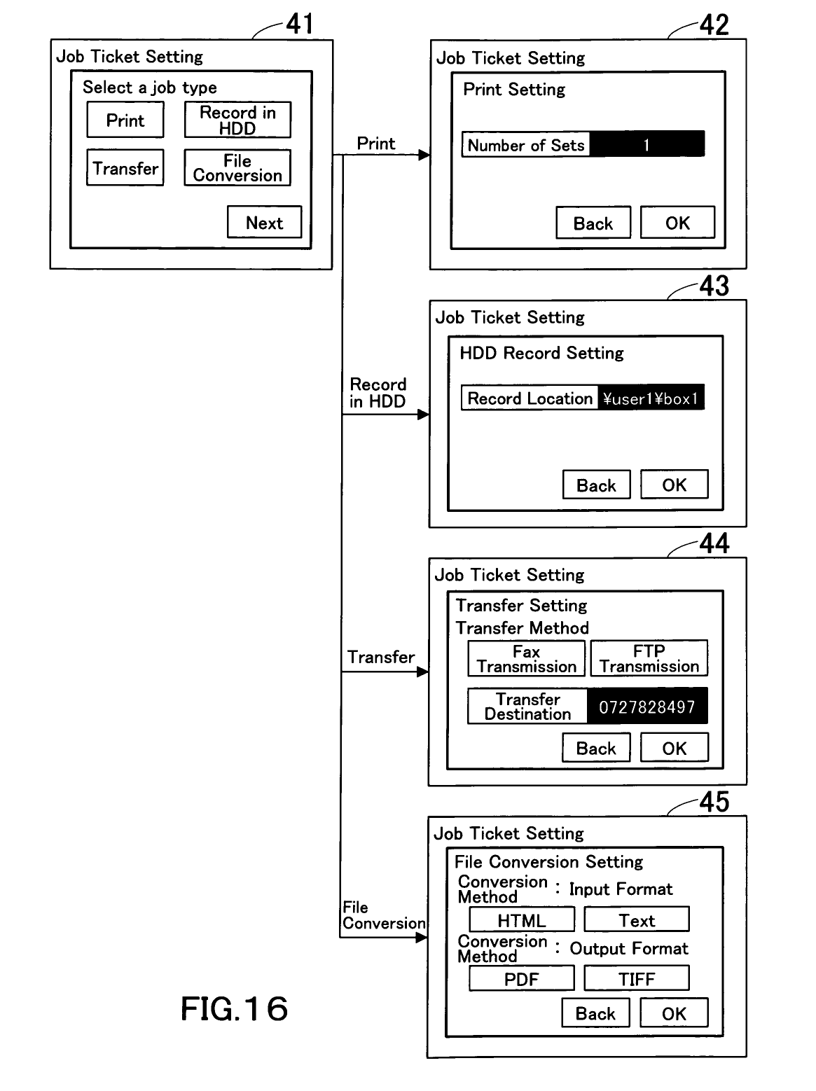

FIG. 16 is a view to explain still yet another embodiment of the present invention. In this embodiment, the image forming apparatus 1 can edit job tickets given to the folders 221 through 224, which are received together with job data stored in the folders, according to user instructions.

Under the control of the integrated controller 11 of the image forming apparatus 1, a job ticket setting screen 41 is displayed on the display 172 of the operation panel 17, by the job ticket edit mode. This is an example of the screen that is displayed in a case where four job tickets: a job ticket for print jobs, a job ticket for record jobs, a job ticket for transfer jobs and a job ticket for file conversion jobs, are received.

When a user selects a “print” button via the screen 41, the screen is switched to a job ticket change screen 42 for editing the job ticket for print jobs, via which the user is allowed to change a print setting (for example, the number of sets to be outputted) specified in the job ticket.

When a user selects a “HDD” button via the screen 41, the screen is switched to a job ticket change screen 43 for editing the job ticket for record jobs, via which the user is allowed to change a record setting (for example, a record location) to record data in the memory 22, specified in the job ticket.

When a user selects a “transfer” button via the screen 41, the screen is switched to a job ticket change screen 44 for editing the job ticket for transfer jobs, via which the user is allowed to change a transfer setting and a transfer method (for example, transfer by FAX or FTP, and a transfer destination) specified in the job ticket.

When a user selects a “file conversion” button via the screen 41, the screen is switched to a job ticket change screen 45 for the job ticket for file conversion jobs, via which the user is allowed to change a file conversion setting (for example, an input format and an output format) specified in the job ticket.

As described above in this embodiment, it is advantageous that users using the image forming apparatus 1 can easily edit job conditions that are given by the portable terminal apparatus 2 to the folders 221 through 224.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A job execution system having a portable terminal apparatus and a job execution apparatus capable of being interconnected, wherein:
the portable terminal apparatus comprises:
a storage that stores in itself job data or reference information pointing to the job data;
a communicator that establishes a connection between the portable terminal apparatus and the job execution apparatus, and thereafter performs communication between the portable terminal apparatus and the job execution apparatus; and
a transmitter that transmits to the job execution apparatus the job data or the reference information stored in the storage, and
the job execution apparatus comprises:
a communicator that establishes a connection between the portable terminal apparatus and the job execution apparatus, and thereafter performs communication between the portable terminal apparatus and the job execution apparatus;
a receiver that receives the job data or the reference information transmitted from the portable terminal apparatus; and
an executor that executes a job that is related to the received job data or the job data obtained from an address referred to by the received reference information,
and wherein:
the transmitter of the portable terminal apparatus transmits to the job execution apparatus the job data or the reference information, if establishment of a connection between the portable terminal apparatus and the job execution apparatus is detected on the portable terminal apparatus, or alternatively, if establishment of a connection between the portable terminal apparatus and the job execution apparatus is detected on the job execution apparatus and then a request for the job data or the reference information is transmitted to the portable terminal apparatus from the job execution apparatus.

2. The job execution system recited in claim 1, wherein both the connection is established and the communication is performed, by a close range wireless communication system.

3. The job execution system recited in claim 1, wherein the storage of the portable terminal apparatus has at least one folder to store the job data or the reference information, and the transmitter of the portable terminal apparatus transmits to the job execution apparatus the job data or the reference information stored in the folder.

4. The job execution system recited in claim 2, wherein the connection is established by a close range wireless system, and thereby the portable terminal apparatus obtains information of the job execution apparatus that is a transmission destination and then transmits the job data or the reference information to an address indicated by the obtained information.

5. The job execution system recited in claim 1, wherein:
the storage of the portable terminal apparatus has at least one folder to store the job data or the reference information; and
the portable terminal apparatus further comprises a setting portion that is capable of specifying about each folder whether or not to transmit the job data or the reference information if establishment of the connection is detected.

6. The job execution system recited in claim 5, wherein the setting portion is further capable of specifying about each image forming apparatus, whether or not to transmit the job data or the reference information if establishment of the connection is detected.

7. The job execution system recited in claim 1, wherein:
the storage of the portable terminal apparatus has at least one folder to store the job data or the reference information; and
the portable terminal apparatus further comprises a folder creator that creates a folder if not having any folder when establishment of the connection is detected.

8. The job execution system recited in claim 7, wherein the folder creator creates at least one folder by using an application program for folder creation, which is obtained from the job execution apparatus.

9. The job execution system recited in claim 1, wherein:
the storage of the portable terminal apparatus has at least one folder to store the job data or the reference information, and the folder is created for each job type; and
the portable terminal apparatus transmits to the job execution apparatus the job data or the reference information stored in the folder.

10. The job execution system recited in claim 9, wherein the folder is at least one from a folder for print jobs, a folder for record jobs to record job data in a memory of the job execution apparatus, a folder for transfer jobs to transfer job data from the job execution apparatus to an external device, and a folder for file conversion jobs.

11. The job execution system recited in claim 9, wherein the folder has a given job condition appropriate for its job type.

12. The job execution system recited in claim 11, wherein the job execution apparatus further comprises an editor that edits a job condition given to the folder.

13. The job execution system recited in claim 7, wherein the folder creator creates at least one folder for each job type.

14. The job execution system recited in claim 1, wherein the storage of the portable terminal apparatus has at least one folder to store the job data or the reference information, and the folder has a registered PIN code that is used to establish the connection by a close range wireless communication system.

15. A portable terminal apparatus comprising:
a storage that stores in itself job data or reference information pointing to the job data;
a communicator that establishes a connection with a job execution apparatus, and thereafter performs communication with the job execution apparatus;
a detector that detects establishment of a connection with the job execution apparatus; and
a transmitter that transmits to the job execution apparatus the job data or the reference information stored in the storage, if the detector detects establishment of a connection with the job execution apparatus, or alternatively, if establishment of a connection with the job execution apparatus is detected on the job execution apparatus and then a request for the job data or the reference information is received from the job execution apparatus.

16. A job execution apparatus comprising:
a communicator that establishes a connection with a portable terminal apparatus, and thereafter performs communication with the portable terminal apparatus;
a detector that detects establishment of a connection with the portable terminal apparatus;
a requester that transmits to the portable terminal apparatus a request for job data or reference information pointing to the job data, if the detector detects establishment of a connection with the portable terminal apparatus;
a receiver that receives the job data or the reference information transmitted from the portable terminal apparatus in response to the request issued by the requester; and
an executor that executes a job that is related to the received job data or the job data obtained from an address referred to by the received reference information.

17. A job data transmission method of a portable terminal apparatus, comprising:
storing in a storage job data or reference information pointing to the job data;
establishing a connection with a job execution apparatus;
detecting establishment of a connection with the job execution apparatus; and
transmitting to the job execution apparatus the job data or the reference information stored in the storage, if establishment of a connection with the job execution apparatus is detected.

18. A job data receiving method of a job execution apparatus, comprising:
establishing a connection with a portable terminal apparatus;
detecting establishment of a connection with the portable terminal apparatus;
transmitting to the portable terminal apparatus a request for job data or reference information pointing to the job data, if establishment of a connection with the portable terminal apparatus is detected;
receiving the job data or the reference information transmitted from the portable terminal apparatus in response to the request; and
executing a job that is related to the received job data or the job data obtained from an address referred to by the received reference information.

19. A computer readable recording medium having a job data transmission program recorded therein to make a computer of a portable terminal apparatus execute:
storing in a storage job data or reference information pointing to the job data;
establishing a connection with a job execution apparatus;
detecting establishment of a connection with the job execution apparatus; and
transmitting to the job execution apparatus the job data or the reference information stored in the storage, if establishment of a connection with the job execution apparatus is detected.

20. A computer readable recording medium having a job data receiving program recorded therein to make a computer a job execution apparatus execute:
establishing a connection with a portable terminal apparatus;
detecting establishment of a connection with the portable terminal apparatus;
transmitting to the portable terminal apparatus a request for job data or reference information pointing to the job data, if establishment of a connection with the portable terminal apparatus is detected;
receiving the job data or the reference information transmitted from the portable terminal apparatus in response to the request; and
executing a job that is related to the received job data or the job data obtained from an address referred to by the received reference information.
